(19) United States
(12) Patent Application Publication
(10) Pub. No.: US 2025/0118450 A1
(43) Pub. Date: Apr. 10, 2025

(54) Thermal Wave Drive for ICF Targets

(71) Applicants: Robert O. Hunter, Jr., Aspen, CO (US); Eric W. Cornell, Colorado Springs, CO (US)

(72) Inventors: Robert O. Hunter, Jr., Aspen, CO (US); Eric W. Cornell, Colorado Springs, CO (US)

(73) Assignee: Innoven Energy LLC, Solana Beach, CA (US)

(21) Appl. No.: 18/376,798

(22) Filed: Oct. 4, 2023

(51) Int. Cl. G21B 1/19; G21B 1/03

(52) U.S. Cl. CPC G21B 1/15

(57) ABSTRACT

A system and method for driving an ICF target with a thermal wave comprising: a target assembly, located inside a hohlraum, comprising a drive region, shell region and central fuel region; wherein said hohlraum comprises one or more laser entrance apertures; wherein said one or more laser entrance apertures are sized according to the shape of said hohlraum and to prevent energy from escaping said hohlraum; a laser assembly to irradiate a laser pulse through said laser entrance apertures; inner walls of said hohlraum to reradiate said laser pulse as x-ray radiation; wherein said x-ray radiation penetrates the target assembly as a thermal wave before any significant hydrodynamic motion occurs within said target assembly during the time in which the laser assembly is active; wherein said drive region is evenly heated to a sufficient temperature to expand in an inward and outward direction; and wherein said shell region is launched into said fuel region to drive said ICF target.

### CROSS-REFERENCE TO RELATED APPLICATIONS

This application claims the benefit of provisional U.S. Application No. 63/412,172 filed on Oct. 4, 2022, which is incorporated herein by reference.

### BACKGROUND

Inertial Confinement Fusion (“ICF”) is a process by which energy is produced by nuclear fusion reactions. The fuel pellet, generally called the target, is conventionally a spherical device which contains fuel for the fusion process. Various ways of driving and imploding the target have been utilized and considered (lasers, ion beams, etc.). These drives transfer energy to the target which then implodes and ignites the fuel. If the fuel is sufficiently heated and compressed, a self-sustaining fusion reaction occurs, wherein the fuel self-heats and produces energy from the fusion reaction.

If the target is to be useful for energy production, it must output more energy than the amount of energy needed to drive the implosion. The amount of energy needed to drive the target may be quite high, as very high temperatures and densities are required to initiate fusion reactions. Also, the amount of energy needed to drive the target must be physically and economically achievable.

The conventional approach to ICF target design is exemplified by the Department of Energy's program, NIF (National Ignition Facility). NIF target designs, as described in Lindl, “The Physics Basis for Ignition Using Indirect Drive Targets on the National Ignition Facility”, consists of a mostly plastic or beryllium ablator region which surrounds a cryogenic DT ice, and a central void which is filled with very low-density DT gas. The target is then placed in a cylindrical hohlraum. The entire target assembly (hohlraum and target) are then placed in the target chamber, where a 192-beamline laser delivers up to 1.8 MJ of energy to the hohlraum. The hohlraum converts the energy to x-rays which then ablate the ablator region, and by the reactive force drives the DT shell inward. This ablation process may take a very long time in comparison to the hydrodynamic motion of the target material. Due to this long time-scale, NIF hohlraums must have very large laser entrance holes. As the temperature of the hohlraum rises, the material will be ablated and thereby begin to close these holes. If the holes close or become too small, the laser light will not be able to enter the hohlraum. One effect of having these large holes is that radiation is then allowed to escape the hohlraum and that energy then becomes unusable by target. Another effect of a long laser pulse is that although the hohlraum walls are fairly reflective to radiation, a significant portion of the laser energy is lost to the heating of the hohlraum walls. This means NIF targets are unable to efficiently use the energy from the laser.

Since the time scale of the laser pulse length must be long for this ablation process, the target and/or hohlraum may move during the laser pulse. If this happens there may be increased non-uniformity of the energy deposition on the target's surface. This increased non-uniformity may lead to increased Raleigh-Taylor instability growth at the shell/fuel interface and ignition failure.

Unless otherwise indicated herein, the materials described in this section are not prior art to the claims in this application and are not admitted to be prior art by inclusion in this section.

### SUMMARY

ICF targets and their designs are discussed in which less energy is lost to heating the hohlraum, as well as less energy escaping the laser entrance holes by reducing the size of these holes. This necessarily reduces the laser pulse length in time and changes the requirements for how those targets are driven. These targets may then also benefit from improved stability and symmetry requirements.

In accordance with the present invention, a system and method for driving an ICF target with a thermal wave is described. The ICF target is located within a hohlraum which comprises one or more laser entrance apertures sized accordingly. A laser assembly irradiates a laser pulse through the laser entrance apertures to reradiate as x-ray radiation within the inner walls of the hohlraum to penetrate the ICF target as a thermal wave. A drive region is then evenly heated to a sufficient temperature to expand in an inward and outward direction wherein a shell region is launched into a fuel region to drive the ICF target.

### DRAWINGS

FIG. 1 shows (a) a thermal wave and (b) an ablative heating wave.

FIG. 2 shows one embodiment in which a drive region surrounds a high Z shell, which then surrounds a fuel region.

FIG. 3 shows a target assembly (spherical target and cylindrical hohlraum).

FIG. 4 shows one example of a cylindrical hohlraum having laser entrance apertures on both ends.

### TERMINOLOGY AND REFERENCE NUMERALS

| | |
|---|---|
| 102 | Ambient Material (AM), areal density = ρ_{A} |
| 104 | Shocked Material (SM), areal density > ρ_{A} |
| 106 | Rarefacted Material (RM), areal density < ρ_{A} |
| 108 | Vacuum (V) or Ambient Atmosphere Outside of Shell Material |
| 110 | Temperature (T) |
| 112 | Thermal Wave Material Temperature Profile (Tₚ) |
| 114 | Ablative Wave Material Temperature Profile (Tₚ′) |
| 116 | External or Incoming Radiation (qₑₓ) |
| 118 | Propagation Front (F) of the Thermal Wave |
| 200 | Target |
| 202 | Central Fuel Region |
| 204 | Shell Region |
| 206 | Drive Region |
| 300 | Hohlraum |
| 302 | Entrance Aperture of Hohlraum |
| 304 | Hohlraum Walls |
| 400 | Target Assembly |

### DETAILED DESCRIPTION

Nuclear fusion may refer to a type of reaction that occurs when certain atomic nuclei collide. In most of these reactions, two light nuclei combine, producing heavier nuclei and/or nuclear particles. In the process, some of the energy in the nuclear bonds holding the nuclei together is released, usually settling in the form of thermal energy (heat) in the material surrounding the reacting particles. These reactions only occur between atomic nuclei that are very energetic, such as those that have been heated to a high temperature to form a plasma. The specific temperatures vary between reactions. The reaction between deuterium and tritium, two hydrogen isotopes, is generally considered to require the lowest temperature for ignition. As other fusion reactions require higher temperatures, most nuclear fusion power concepts envision the use of D-T fuel.

At ordinary densities and practicable amounts, a D-T plasma heated to ignition temperature will disassemble (expand and stop burning) before producing anywhere near the energy required to originally heat it. However, as the density of a given amount of fuel is increased, the rate at which the fuel will burn increases faster than the rate at which it will expand. This means that, if the fuel can be compressed sufficiently before heating it, the fuel's own resistance to motion (inertia) will keep it from expanding long enough to yield a significant amount of energy. This approach is referred to as Inertial Confinement Fusion (ICF). Inertial Confinement Fusion reactor chambers can be designed to contain an ICF target being imploded and capture the resulting energy output from the reaction in the forms of neutrons, radiation, and/or debris.

The term “Z” refers to the atomic number of an element, i.e., the number of protons in the nucleus. The term “A” refers to the atomic mass number of an element, i.e., the number of protons and neutrons in the nucleus. At the pressures and temperatures involved in imploding and burning ICF targets, specific material properties that one observes in everyday life (hardness, strength, room-temperature, thermal conductivity, etc.) may be irrelevant, and the hydrodynamic behavior of a material can depend most strongly on the material's average atomic number, atomic mass number, and solid density.

As such, in discussing material requirements in ICF targets, it is convenient to discuss classes of material. For the purposes of the following discussion, the term “low-Z” will refer to materials with an atomic number of 1-5 (hydrogen to boron); the term “medium-Z” will refer to materials with an atomic number of 6-47 (carbon to silver); and the term “high-Z” will refer to materials with an atomic number greater than 48 (cadmium and above). Unless otherwise stated, the use of these terms to describe a class of material for a specific function is intended only to suggest that this class of material may be particularly advantageous for that function, and not (for instance) that a “high-Z” material could not be substituted where a “medium-Z” material is suggested, or vice-versa.

The differing solid densities of materials with similar-Z may also important for certain design criteria in some embodiments.

The term “approximately” and “about” refers a given value ranging plus/minus 15%. For example, the phrase “approximately 10 units” is intended to encompass a range of 8.5 units to 11.5 units.

The term “atom” may refer to a particle of matter, composed of a nucleus of tightly-bound protons and neutrons with an electron shell. Each element has a specific number of protons.

The term “neutron” may refer to a subatomic particle with no electrical charge. Their lack of a charge means that free neutrons generally have a greater free range in matter than other particles.

The term “proton” may refer to a subatomic particle with a positive electrical charge.

The term “electron” may refer to a subatomic particle with a negative electrical charge, exactly opposite to that of a proton and having less mass than a proton and a neutron. Atoms under ordinary conditions have the same number of electrons as protons, so that their charges cancel.

The term “isotope” may refer to atoms of the same element that have the same number of protons, but a different number of neutrons. Isotopes of an element are generally identical chemically, but may have different probabilities of undergoing nuclear reactions.

The term “ion” may refer to a charged particle, such as a proton or a free nucleus.

The term “plasma” may refer to the so-called fourth state of matter, beyond solid, liquid, and gas. Matter is typically in a plasma state when the material has been heated enough to separate electrons from their atomic nuclei.

The term “Bremsstrahlung radiation” may refer to radiation produced by interactions between electrons and ions in a plasma. One of the many processes that can cool a plasma is energy loss due to Bremsstrahlung radiation.

The product “ρr” may refer to the areal mass density of a material. This term may refer to a parameter that can be used to characterize fusion burn. This product is expressed in grams per centimeter squared, unless otherwise specified.

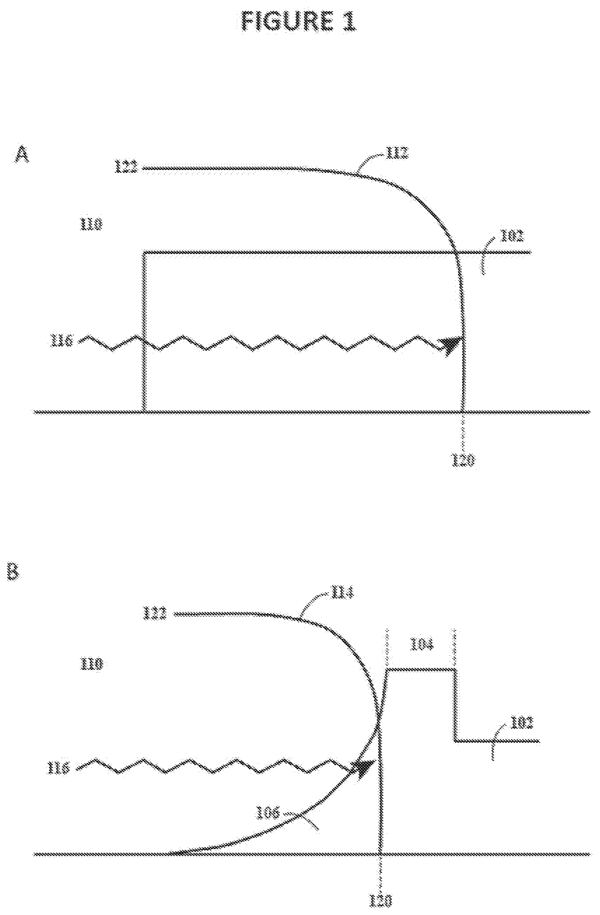

A “thermal wave” may be referred to as a supersonic radiative thermal wave or Marshak wave, and is defined as a direct heat transfer by radiation (x-ray or laser photons) and having the characteristic of propagating through the medium at a speed greater than the speed of sound and without causing any significant hydrodynamic motion to occur within the medium. As described below, FIG. 1a shows the temperature profile and the propagation of front of a thermal wave while FIG. 1b describes the profile of a conventionally used ablative wave.

For incident radiation of temperature (T) 110, the radiative thermal conductivity is a strong and rapidly increasing function of T (˜T^{4.5-5.5}) resulting in a temperature profile 112 (FIG. 1a) deposited in the material which is practically constant from the vacuum or ambient atmosphere region 108 up to the point 118 where it rapidly falls off. Temperature profile 112 and associated front 118 characterizes the intensity and extent of the thermal wave (FIG. 1a). A principal characteristic of thermal waves is the propagation of front 118 at speeds greater than the local sound speed in a medium resulting in a density profile (ρ) substantially unchanged from the material's ambient density (ρ_{A}). Depending on the context, areal density is defined as follows:

Areal Density=∫₀^{r}dr′ρ(r′) or ∫ᵣ₁₀₄^{r}dr′ρ(r′)

Alternatively, at lower intensities/shorter pulse lengths for qₑₓ, a subsonic ablative heating wave 114 (FIG. 1b) is generated. Temperature profile 114 is qualitatively similar to 112 but the propagation speed of front 118 is subsonic resulting in a significant material rarefaction wave 106, and a region of higher density shocked material 104 ahead of front 118. In this scenario, the outer layers of an ICF target may be ablated either directly by laser energy, or indirectly by radiation produced/re-radiated by the inner walls of hohlraum or propellant located within hohlraum. A shockwave is sent into the medium where it may then be driven inwardly through the ablator region.

Therefore, if the external radiation 116 temperature is high enough and/or of short duration, a thermal wave will penetrate the drive region without ablating the surface or generating a shock wave during the interval qₑₓ is on or externally irradiates material. Application of this thermal wave (FIG. 1a) as opposed to the ablative wave (FIG. 1b) is the subject of this application. Conventional ICF applications utilize an ablative wave mechanism as opposed to a thermal wave.

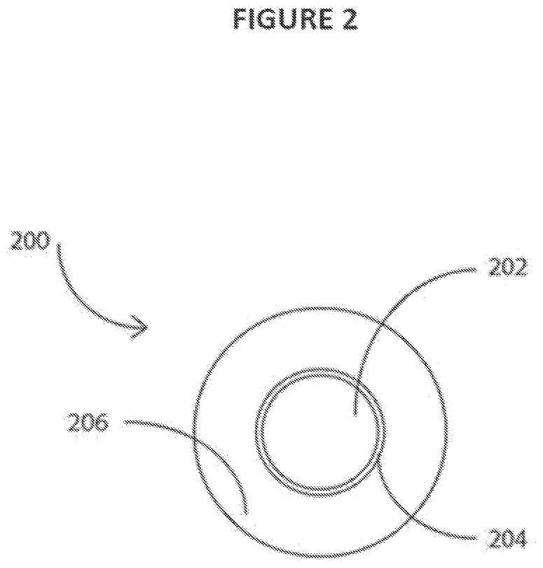

As shown in FIG. 2, spherical target 200 comprises a central fuel region 202, shell region 204 and drive region 206. In a first embodiment of this invention, fuel region 202 may be filled with equimolar deuterium-tritium (DT) at a density of 0.15 g/cc. Fuel region 202 may have an outer radius of 0.078 cm. Fuel region 202 may then be surrounded by shell region 204. Shell region 204 may be solid tungsten metal with an outer radius of 0.083 cm. Surrounding shell region 204 may be a drive/ablator region 206. Drive region 206 may be made of boron nitride at a density of 3.45 g/cc. Drive region 206 may have an outer radius of 0.197 cm.

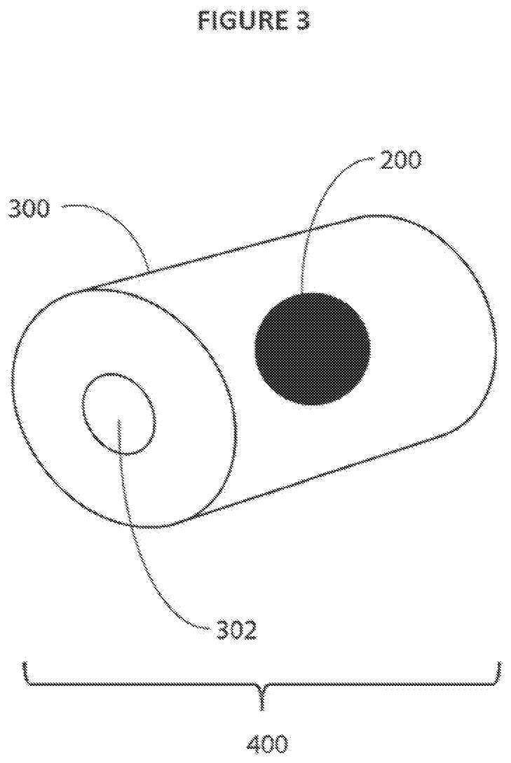

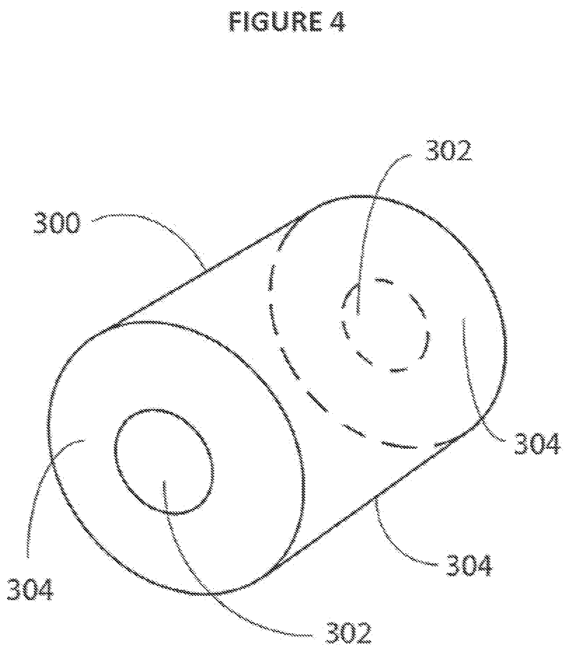

As shown in FIG. 3, target assembly 400 includes both the target 200 and hohlraum 300. Target 200 may be placed in any one of a variety of shaped hohlraums 300 including but not limited to spherical, cylindrical, or rugby shaped (cylindrical shaped is depicted in FIG. 3) having one or more laser entrance apertures 302 appropriate to the shape of hohlraum 300. As shown in FIG. 4, hohlraum 300 may be gold, tungsten, or any high-Z material that is reflective to radiation. The laser light will then enter hohlraum 300 through aperture(s) 302 and illuminate hohlraum 300. Due to the material composition, density, and dimension selected, hohlraum walls 304 will then reradiate the laser energy as x-ray radiation and the radiation field will fill hohlraum 300. Referring back to FIG. 2, if the radiation temperature is sufficiently high enough (as shown in FIG. 1a) and the optimal material and density is selected for the target 200, instead of ablating the exterior of drive region 206, a thermal wave is driven into the material. The drive region has a thermal conductivity rapidly increasing in function at a rate of approximately T^{4.5-5.5}. The thermal wave does not ablate the surface of the drive region nor is a shock driven into the material, but instead propagates at a supersonic speed which then penetrates and ionizes the material before any significant hydrodynamic motion occurs within the target assembly (hohlraum and ICF target) while the laser is activated. Since this thermal wave does not ablate the surface of drive region 206, there is no shock driven into the material, and therefore no change in the density of the material. The entirety of drive region 206 may then be evenly heated to the same temperature of the thermal wave. As the drive region 206 evenly heats, the drive region 206 may then begin to expand in both the outward and inward directions. As drive region 206 expands, shell region 204 will begin to move inwardly. The sudden inward motion of shell 204 will then launch a shock into fuel region 202. This shock will carry some amount of energy with it and begin to heat fuel region 202. During the time said shock is travelling toward the origin of the sphere, shell region 204 will compress fuel region 202 as shell region 204 moves inwardly. If fuel region 202 is sufficiently compressed and heated, fuel region 202 may ignite due to fusion reactions and enter run-away burn where the fusion reactions in fuel region 202 sustain the burning of the fusion fuel.

Drive region 206 could, instead of being a homogenous region, be layered with different materials or the same material at different densities. For instance, if the density of drive region 206 smoothly transitioned from the greatest density on the outside to the least dense on the inside, a longer pressure pulse on the outside of shell 204 would be created as the inner material would push earlier in time and the material further out would follow. The material in drive region 206 could be chosen for its opacity, or lack thereof, to radiation of a certain spectrum or temperature.

Some amount of the laser energy entering hohlraum 300 will heat hohlraum wall 304. This energy never reaches the target and may be thought of as a loss. This loss is highly dependent on the time in which the laser is active. One advantage of this process is the pulse length requirement for the laser. Since the initial heating of ablator region (206, FIG. 2) may occur on a very short time scale (˜1 nanosecond), the laser pulse may also be very short (˜1 nanosecond), thus significantly reducing the energy lost to hohlraum wall (304, FIG. 4). The time scale of about 1 nanosecond and laser pulse of about 1 nanosecond that is required to thermally drive (not ablate) the ICF target is also unique to the art.

Another loss of energy occurs as radiation leaves the hohlraum through holes 302. The larger the holes are, the more energy that is lost through them. The required size of holes 302 is dependent on the length of the laser pulse. The dimension of the holes become important when the inverse Bremsstrahlung absorption length (λ_{IB}) of the laser pulse becomes shorter than the radius (r) of the hole:

$${λ}_{IB} = \frac{{T}_{e}^{1.5}}{200 {Z}_{H} {n}_{e}^{2}} = 0.7 r$$

where nₑ is the electron density units of critical density n_{c}; Tₑ is the electron temperature (keV); and Z_{H} is the average coronal charge state of the plasma fill. Since the wall surrounding hole 302 will be ablated by the radiation field and shrink and possibly close, hole 302 must be large enough to remain open during the time when the laser is active.

Another advantage of this invention is that no significant hydrodynamic motion occurs within target assembly 400 during the time in which the laser is active. However, in conventional ICF targets, a long ablation process where the laser is active for tens of nanoseconds, the target may shift or move in relation to hohlraum 300 and thus create asymmetries in the energy deposited on the surface of the target. These asymmetries may then lead to an asymmetrical implosion, and if the asymmetries are great enough the target may not ignite.

When conventional ICF targets are driven by ablation, the ablation process is used to tailor the pressure profile on the outside of shell 204. However, in ICF targets driven by a thermal wave penetrating drive region 206, it may be preferred to tailor the pressure profile on the outside shell 204 by structuring drive region 206 in different fashions. One can imagine many variations. Drive region 206 could, instead of being a homogenous region, be layered with different materials or the same material at different densities. For instance, if the density of drive region 206 smoothly transitioned from the greatest density on the outside to the least dense on the inside, a longer pressure pulse on the outside of shell 204 would be created as the inner material would push earlier in time and the material further out would follow. The material in drive region 206 could be chosen for its opacity, or lack thereof, to radiation of a certain spectrum or temperature.

In some embodiments fuel region 202 may have a higher ratio of deuterium to tritium, or conversely, a higher ratio of tritium to deuterium. Fuel region 202 could be filled with other types of fusion fuel, such as: pure deuterium fuel, lithium deuteride, lithium deuteride with lithium tritide, equimolar deuterium and tritium (DT) or DT with a reduced or increased fraction of tritium, or proton-Boron 11 (p¹¹B).

Other materials could be substituted for tungsten in shell 204. For instance, copper could be used. The requirement for the material in shell 204 is that it must contain the radiation in fuel region 202 up until ignition. High-Z materials may be preferred to accomplish this as they will be more reflective to said radiation.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g., size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. A system for driving an ICF target with a thermal wave, a supersonic heating wave, comprising:
a hohlraum;
the ICF target located inside said hohlraum comprising: a drive region, a shell region, and a central fuel region;
wherein said drive region further comprises a plurality of distinct materials arranged in a layered fashion;
one or more laser entrance apertures located within said hohlraum;
a laser assembly to irradiate a laser pulse energy through said one or more laser entrance apertures for a duration of a 1 nanosecond activation time;
a plurality of inner walls to define the shape of the hohlraum, wherein said inner walls are configured to reradiate said laser pulse energy as x-ray radiation;
the plurality of inner walls of the hohlraum are configured to reemit said x-ray radiation toward said drive region;
said drive region is configured to propagate said thermal wave, a supersonic heating wave, having a thermal conductivity rapidly increasing in rate as a function of approximately T^{4.5-5.5};
wherein the plurality of distinct materials of said drive region are configured to propagate said thermal wave within said drive region without any significant hydrodynamic motion during the 1 nanosecond that the laser assembly is activated;
wherein said drive region is heated to a same temperature of said thermal wave; and
said drive region is configured to evenly heat as it expands in an inward and outward direction to launch said shell region into said central fuel region to drive said ICF target.

2. The system of claim 1, wherein the plurality of distinct materials of the drive region are materials each having different densities.

3. The system of claim 2, wherein the densities of the plurality of distinct materials of the drive region are arranged in a smooth transition from a higher density material on the outside to a less dense material on the inside.

4. The system of claim 3, wherein said hohlraum is selected from one of the following shapes: spherical, cylindrical or rugby shaped.

5. A method for driving an ICF target with a thermal wave, a supersonic heating wave, comprising:
irradiating a laser pulse energy through one or more laser entrance apertures of a hohlraum toward a target for a duration of a 1 nanosecond activation time, wherein said target comprises a drive region, shell region and central fuel region;
configuring said one or more laser entrance apertures to be sized according to the shape of said hohlraum and to prevent energy from escaping said hohlraum;
selecting a material and shape of inner walls of said hohlraum to reradiate said laser pulse energy as x-ray radiation upon interaction with the inner walls of said hohlraum;
penetrating the drive region of said target with the x-ray radiation to drive said thermal wave, the supersonic heating wave, having a thermal conductivity rapidly increasing in rate as a function of approximately T^{4.5-5.5};
propagating said thermal wave within said drive region before any significant hydrodynamic motion occurs within said target during the 1 nanosecond in which the laser assembly is active;
evenly heating said drive region to the same temperature of said thermal wave; and
launching said shell region into said fuel region to drive said ICF target.

6. The method of claim 5, further comprising:
irradiating said drive region having a plurality of distinct materials each having different densities arranged in a layered fashion.

7. The method of claim 6, further comprising:
irradiating said drive region wherein the densities of the plurality of distinct materials of the drive region are arranged in a smooth transition from a higher density material on the outside to a less dense material on the inside.

8. The method of claim 7, further comprising:
irradiating a spherical, cylindrical or rugby shaped hohlraum.
